(19) United States
(12) Patent Application Publication
(10) Pub. No.: US 2003/0171949 A1
(43) Pub. Date: Sep. 11, 2003

(54) Method and apparatus for organizing, accessing and displaying data relating to trademark rights

(76) Inventors: Donald Alois Degnan, Boulder, CO (US); Scott Havlick, Boulder, CO (US)

Correspondence Address: HOLLAND & HART, LLP, 555 17TH STREET, SUITE 3200, DENVER, CO, 80201, US

(21) Appl. No.: 10/369,855

(22) Filed: Feb. 19, 2003

Related U.S. Application Data
(63) Continuation-in-part of application No. 10/079,627, filed on Feb. 19, 2002.

(51) Int. Cl. G06F 17/60

(52) U.S. Cl. 705/1

(57) ABSTRACT

An interactive user interface for presenting information associated with assessing, monitoring and maintaining the scope of rights in a trademark. Information relevant to defining the scope of rights in a trademark is visually depicted in an interactive user interface in a manner making it easy to visualize the scope of rights in a trademark and to identify factually analogues circumstances that bear on the scope of rights enjoyed by a trademark. Over time additional third party uses, enforcement actions, licenses, acquisitions and registrations can be added to the interface without disturbing the integrity of the interface.

### CROSS-REFERENCE TO RELATED APPLICATIONS

This application is a continuation-in-part of U.S. application Ser. No. 10/079,627 entitled METHOD AND APPARATUS FOR ORGANIZING, ACCESSING AND DISPLAYING DATA RELATED TO TRADEMARK RIGHTS and filed by Scott Spenser Havlick and Donald Alois Degnan on Feb. 19, 2002, which application is herein incorporated by reference in its entirety.

### BACKGROUND OF THE INVENTION

1. Field of the Invention

The present invention relates, in general, to trademarks. More particularly, the present invention is directed to a method and apparatus for assessing, monitoring and maintaining the scope of rights in a trademark.

2. Relevant Background

A trademark portfolio is a valuable asset. In most cases, however, the portfolio's significance cannot be assigned a dollar value that is directly attributable to a company's profitability. Instead, trademarks create brand recognition amongst consumers and potential consumers. As a product or service acquires good will in the mind of consumers and potential consumers, the trademark becomes the vehicle for accumulating and generating future revenues from that good will. In essence, a trademark makes it easier for consumers to quickly confirm the source and verify the quality of a good or service sold under the trademark.

A trademark owner's ability to distinguish its goods or services from those of its competitors varies according to the strength of the trademark that is used to sell the trademark owner's goods or services. If the trademark owner adopts a distinctive mark, and effectively uses and enforces its trademark rights, the trademark owner should be able to prevent others from selling directly competing, related or sometimes even unrelated goods or services under a confusingly similar mark.

Typically, a trademark owner will consult with a trademark professional to advise the owner on how to maximize the scope of enforceable rights for a given trademark. The trademark professional will often utilize a trademark searching company to fully search a proposed new trademark to determine whether and how the proposed new trademark is being used by others. The trademark professional also monitors the use of the trademark and similar marks to identify any potential effects on the scope of rights. The trademark owner, for example, may increase the scope of enforceable rights in a given trademark by acquiring rights in other marks. On the other hand, a trademark owner's acquiescence to third party uses of similar marks on similar goods and/or services can subsequently narrow the scope of the trademark owner's rights in a mark.

Each new third party use presents a unique enforcement dilemma to the trademark owner. Does that use infringe the trademark owner's scope of rights? What precedent will the trademark owner create by declining to pursue the newly-identified third party? Has the trademark owner declined to pursue other similarly situated third parties in the past?

The volume of information associated with a trademark, such as enforcement, litigation and investigation information, can be substantial. The gathering, storage and dissemination of trademark information can be an onerous task for even a single mark. Many trademark owners have portfolios of dozens and even hundreds of marks. These marks are often handled by numerous trademark professionals in different geographic locations. In many instances, the right hand may not know what information the left hand holds. It is easy for information to get lost, misplaced or overlooked. In some extreme cases, tasks may be duplicated or missed, all at a considerable cost to the trademark owner.

In every instance, there is a need to cull through and identify the most important information related to a particular mark. Many high level executives are time pressed and cannot devote large blocks of time to understanding the vast amount of information associated with their company's trademark portfolio. Similarly, business meetings discussing a single mark or group of marks are also time critical. The time available to present understandable information is at a premium. The important information can be difficult to locate, decipher and understand without an exhaustive review of all the information related to the trademark. It is therefore desirable to centrally organize, access and graphically present information associated with a trademark in a quick, simple and efficient manner.

### SUMMARY OF THE INVENTION

The foregoing and other features, utilities and advantages of the invention will be apparent from the following more particular description of a preferred embodiment of the invention as illustrated in the accompanying drawings.

A method and system are provided for assessing, monitoring and maintaining the scope of rights in a trademark. A method for managing a trademark portfolio includes maintaining a database including a plurality of mark records wherein each of the records includes a plurality of entries. A user interface is provided to for selecting at least one mark record, and a display device displays the plurality of entries for the selected mark. A link to further information for at least one of the entries is also provided.

A system for managing a trademark portfolio is also provided. The system includes a database having a plurality of mark records each including a plurality of entries. A user interface is operable to select a first mark record, and a display device is operable to display the entries of the selected mark record. The interface further provides a link to further information for at least one of the entries.

### BRIEF DESCRIPTION OF THE DRAWINGS

FIG. 1 is a first system diagram of a computer network environment for implementing the present invention;

FIG. 2 is a second system diagram of a computer network environment for implementing the present invention;

FIG. 3 illustrates a graph having a first axis having a plurality of goods and/or services descriptions and a second axis having a plurality of mark descriptions;

FIG. 4 illustrates a graph populated with several user selectable data points showing shading in accordance with the properties of the underlying trademark;

FIG. 4A illustrates a graph having a first axis having a plurality of International classes and a second axis having a plurality of mark descriptions;

FIG. 5 is a graph having a user selectable data point showing the blowout box for placing the mouse cursor over the data point;

FIG. 6 shows two graphs, the mark descriptions and the goods and/or services descriptions from second graph are chosen from the first graph;

FIG. 7 illustrates a graph with a third axis illustrating how the GUI can be used to assess a trademark owner's scope of rights or position in multiple foreign countries;

FIGS. 8-9 are flow charts illustrating the method of the present invention;

FIG. 10 is a third system diagram of a computer network environment for implementing the present invention;

FIG. 11 illustrates a screen shot of an exemplary user interface of a portfolio management tool of the present invention;

FIG. 12 illustrates a screen shot of the user interface depicted in FIG. 11;

FIG. 13 illustrates another screen shot of the user interface depicted in FIGS. 11 and 12;

FIG. 14 illustrates yet another screen shot of the user interface depicted in FIGS. 11-13;

FIG. 15 illustrates another screen shot of the user interface depicted in FIGS. 11-14;

FIG. 16 illustrates a screen shot of another exemplary user interface for depicting portfolio information related to a mark;

FIG. 17 illustrates exemplary data fields for use in the user interface depicted in FIG. 16;

FIG. 18 illustrates the user interface depicted in FIG. 16 showing portfolio information related to an exemplary mark;

FIG. 19 illustrates a graphical image of the exemplary mark depicted in FIG. 18;

FIG. 20 illustrates yet another exemplary user interface for depicting information related to the owner of the mark depicted in FIGS. 18 and 19;

FIG. 21 illustrates another exemplary user interface for depicting portfolio information related to the mark shown in FIGS. 18-20;

FIG. 22 illustrates yet another exemplary user interface for depicting portfolio information related to the mark shown in FIGS. 18-21;

FIG. 23 illustrates another exemplary user interface for depicting portfolio information related to the mark shown in FIGS. 18-22; and

FIG. 24 illustrates another exemplary user interface for depicting portfolio information related to the mark shown in FIGS. 18-23.

### DESCRIPTION OF THE SPECIFIC EMBODIMENTS

The trademark professional is constantly seeking techniques to streamline the process for receiving and presenting information associated with a trademark search, follow up investigations and clearance activities, as well as information received from watch notices, enforcement actions and other factual developments affecting a trademark's scope of rights after a mark is adopted.

The trademark search and the follow up clearance work that is conducted based upon information contained in the search report is used to aid in the decision of whether to adopt a trademark. The trademark professional analyzes the resulting research report to assess the potential conflicts that may accompany use of the proposed mark.

The information compiled relating to a mark is typically used by the trademark professional to assess the scope of rights available to a trademark. Sometimes, in order to reach these conclusions, the trademark professional will require detailed analysis of a variety of factual records. It is important to assess the scope of rights for a particular trademark, because the trademark owner's actions can dramatically broaden or narrow the scope of rights for any given trademark. Trademarks with earlier priority dates can be acquired by the trademark owner, effectively broadening the scope of protection that can be expected for the newly adopted mark. On the other hand, a trademark owner's acquiescence to third party uses of similar marks on similar goods and/or services can subsequently narrow the scope of the trademark owner's rights in a mark.

A trademark owner is obliged to vigilantly monitor third party use of the trademark. Often opposition proceedings, cancellation actions and civil litigation are required of the trademark owner to maintain the full scope of rights in a trademark. Tracking many enforcement decisions, settlement and license agreements, acquisitions and co-existence agreements is crucial to consistent interpretation and enforcement of a trademark's scope of rights. This in turn assures that a mark's equity potential is maximized.

A trademark watch service is often employed by the trademark owner or trademark professional to assist in this policing function. A watch service will provide the trademark owner or professional with notification of any similar or related mark on any similar or related goods or services. Watch services can be engaged to monitor federal, state, and foreign trademark offices and provide notification of new applications and/or new registrations, as well as newly published marks. Watch services are also available to watch a wide variety of databases looking for infringing uses of a mark in telephone directories, secretary of state corporate filings, on the Internet, in online directories and databases, and a wide variety of other sources.

Although aspects of the invention are described using the term “trademark”, a person skilled in the art can appreciate that the more general expression “trademark” may also apply to trade names, service marks, trade dress, collective membership marks, collective trademark/service marks, certification marks and other identifiers without departing form the intended scope of the invention.

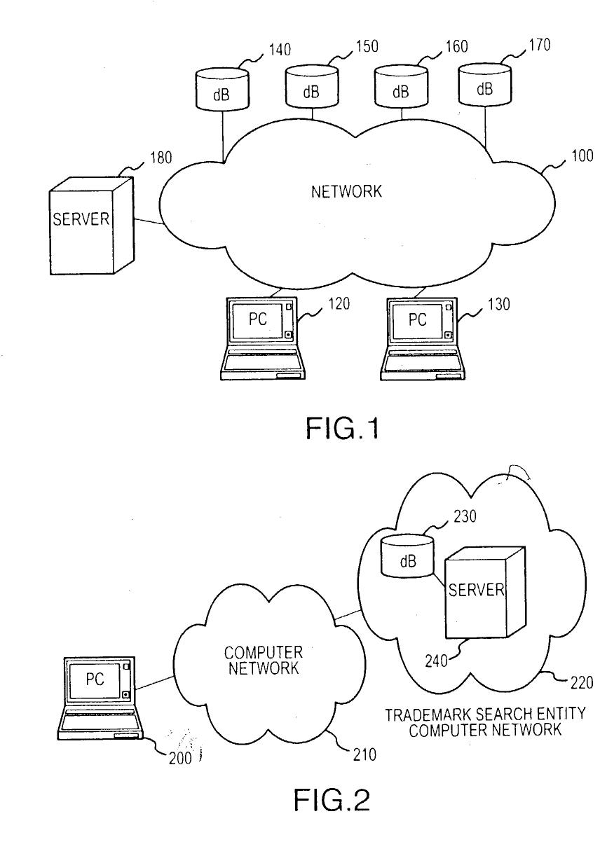

FIG. 1 shows a basic structure of a computer network suitable for use with the method and apparatus of the present invention. In FIG. 1, computer network 100 is coupled to a plurality of databases 140, 150, 160 and 170. Computer network 100 is also coupled to computers 120 and 130 such that both have access to databases 140, 150, 160 and 170. Network 100 may be implemented as a local area network (LAN), a wide area network (WAN), a wired network, a wireless network, a combination wired and wireless, a public network, a private network, an intranet, an extranet, an Internet or any other similar computer and storage based networking environment. The devices may be interconnected in different ways from that shown in FIG. 1. The operation of a computer network such as that shown in FIG. 1 is readily known in the art and is not discussed in detail in this application.

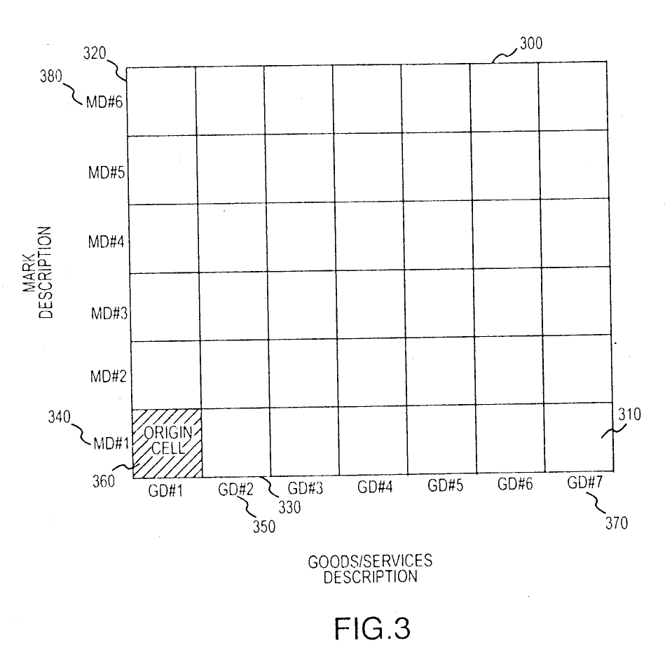

FIG. 2 illustrates a computer network more particularly directed to the interaction between the trademark professional and the trademark search entity. Personal computer 200 is coupled to a computer network 210. A personal computer 200 is showed for exemplary purposes only, the computer 200, however, may alternatively be implemented utilizing computers, such as a mainframe computer, a mini computer, a workstation and the like. Computer network 210 may be implemented as a local area network (LAN), a wide area network (WAN), a wired network, a wireless network, a combination wired and wireless, a public network, a private network, an intranet, an extranet, an Internet, a fibre channel network or any similar computer network that allows communication between a user and a remote storage location. Trademark search entity computer network 220 is coupled to computer network 210 thereby giving multiple users the ability to connect from remote locations. Trademark search entity computer network 220 comprises a server 240 and a database 230. Server 240 provides a location for hosting the processing power to implement the computer software in accordance with the present invention. Database 230 provides a memory location to store any information accessible by computer network 210. Personal computer 200 is intended for use by the trademark professional to communicate with trademark search entity 220 over computer network 210. Although FIG. 2 depicts the trademark search entity computer network 220 hosting database 230 accessible by the computer network 210, one skilled in the art would recognize that other configurations are possible. For example, the computer 200 may include the database locally and the database 230 can be updated directly by the trademark search entity via the network 210. Alternatively, or additionally, the computer 200 can update the database 230 using data received from the trademark search entity, such as downloaded information, electronically transmitted information (e.g., e-mail, instant messaging and the like) or information received from the entity on various media, such as CD-ROM, CD-RW, DVD-ROM, DVD-RAM, optical disks, tapes and the like.

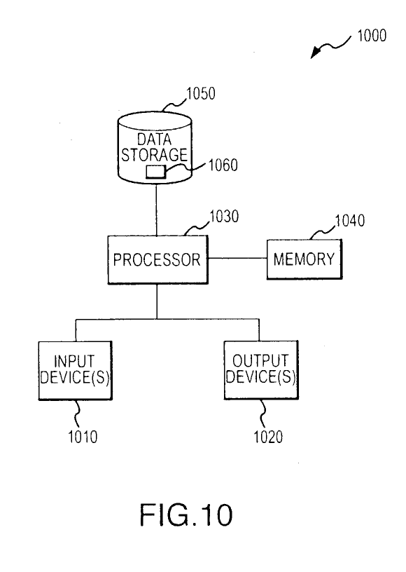

FIG. 10 shows yet another exemplary computer system 1000 that may be used within the scope of the present invention. The computer system 1000 includes one or more input devices 1010, such as a keyboard, a mouse, a track ball, a CD-ROM drive, a CD-RW drive, a floppy drive, and the like. The computer system further includes one or more output devices 1020, such as a display, a printer and the like. The computer system also includes a processor 1030, memory 1040, and one or more data storage device 1050. The data storage device can include any suitable data storage device for storing a database 1060. The database 1060 may be stored in a single data storage device, or may include multiple portions stored in different storage devices. The data storage device(s) may include a hard drive, an optical drive, a tape drive, a CD-ROM drive, a CD-RW drive, a DVD-ROM drive, a DVD-RAM drive and other data storage devices known in the art. The computer system 1000, for example, may be implemented in a single standalone computer such as a personal computer (PC) (such as an IBM-compatible PC, a Macintosh sold by Apple Computer, Inc.), a workstation or the like. In this embodiment, for example, the database may be stored on a hard drive and the processor may update the database with data received from a local input device, such as a CD-ROM drive, a CD-RW drive, a floppy drive, and the like. The processor may also update the database with data received remotely from a network. The network, for example, may include a local area network (LAN), a wide area network (WAN), a wired network, a wireless network, a combination wired and wireless, a public network, a private network, an intranet, an extranet, an Internet and the like. Similarly, components of the computer system, such as the data storage device 1050, may be implemented to connect with the processor 1030 over a network. Alternatively, the computer system 1000 may be implemented in the computer systems described above with respect to FIGS. 1 and 2.

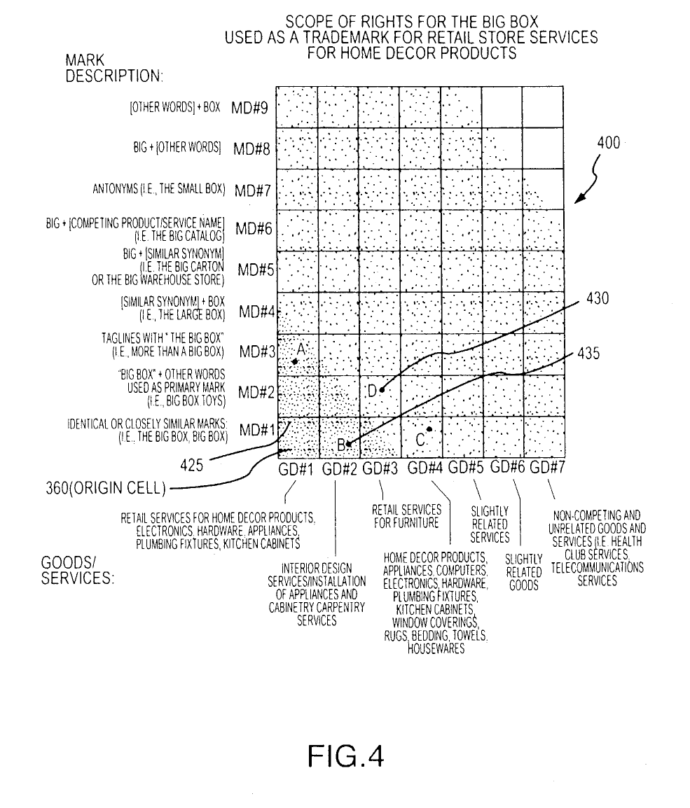

FIG. 3 illustrates an unpopulated graphical user interface (GUI) or graph 300 in accordance with one embodiment of the present invention. Graph 300 is formed by a first axis 330 and a second axis 320. The intersection of the first and second axis forms the origin 360 of the graph 300.

The goods and/or services description and the mark description associated with the trademark subject to the trademark search may form the goods and/or services description and the mark description associated with the origin 360. Origin 360 serves as the reference point for populating the remaining goods and/or services descriptions and mark descriptions along the first axis 330 and the second axis 320, respectively. In accordance with another aspect of the invention, GD#1 350 may recite the goods and/or services description associated with the subject trademark. Similarly, MD#1 340 may recite the mark description associated with the subject trademark.

The first axis 330 is populated with a plurality of goods and/or services descriptions, labeled on graph 300 as GD#1 350 to GD#7 370 respectively. The goods and/or services descriptions may be chosen before or after performing the trademark search. On the front end of the trademark search, the trademark professional may designate certain goods and/or services descriptions in accordance with goods and services currently offered by the owner of the trademark. If known, the trademark professional may also designate certain goods and/or services descriptions in accordance with prospective products intended to be offered by the owner of the trademark. On the back end, the trademark search entity may determine the goods and/or services descriptions associated with first axis 330 according to the results of the search report or some other criteria internal to the search entity. The plurality of goods and/or services descriptions may be automatically generated according to the goods and/or services description associated with the subject trademark or according to the search results, or they may be manually generated by the search entity based on criteria provided by the trademark professional.

The plurality of goods and/or services descriptions are prioritized on the first axis 330 according to their respective similarity with the goods and/or services description associated with origin 360. In graph 300, GD#1 350 may have the identical goods and/or services description of the origin, whereas GD#7 may have little in common. For example, if the goods and/or services description associated with origin 360 is “electrically powered construction tools,” GD#1 may be designated “construction tools” whereas GD#7 may be designated “computer furniture.” As one skilled in the art can fully appreciate, the goods and/or services descriptions associated with first axis 330 will be more closely related for crowded art fields having overlapping goods and/or services descriptions.

The second axis 320 is populated with a plurality of mark descriptions, labeled on graph 300 as MD#1 340 to MD#6 380. Similar to the goods and/or services descriptions, the mark descriptions may be chosen before or after performing the trademark search. On the front end of the trademark search, the trademark professional may designate certain mark descriptions in accordance with variations of the words and letters associated with the trademark. On the back end, the trademark search entity may determine the mark descriptions associated with second axis 320 according to the results of the search report or some other criteria internal to the search entity. The plurality of mark descriptions may be automatically generated according to the mark description associated with the subject trademark or according to the search results, or they may be manually generated by the search entity based on criteria provided by the trademark professional.

The plurality of mark descriptions are prioritized on the second axis 320 according to their respective similarity with the mark description associated with origin 360. In graph 300, MD#1 340 may have the identical goods and/or services description of the origin, whereas MD#6 380 may have only a single word in common. For example, if the mark description associated with origin 360 is “THE MEAN BEAVER” for a chainsaw, MD#1 may be designated “MEAN BEAVER” or “THE MEAN BEAVER” whereas MD#7 may be designated “BEAVER+other words” such as “BEAVER TEETH.” As one skilled in the art can fully appreciate, the mark descriptions associated with second axis 320 will be more closely related for crowded art fields having many similar mark descriptions.

The boundary of a grid in graph 300 is delineated by the goods and/or services description and the mark description on the respective intersecting first and second axis. For example, grid 310 is formed by the intersection of MD#1 340 and GD#7 370 respectively. The right and left edges of grid 310 comprise the boundary of the right and left edge of GD#7 370. The top and bottom edges of grid 310 comprise the top and the bottom edge of MD#1 340. Therefore, a mark plotted within grid 310 would have a description of goods and/or services in accordance with GD#7 370 and a mark description in accordance with MD#1 340.

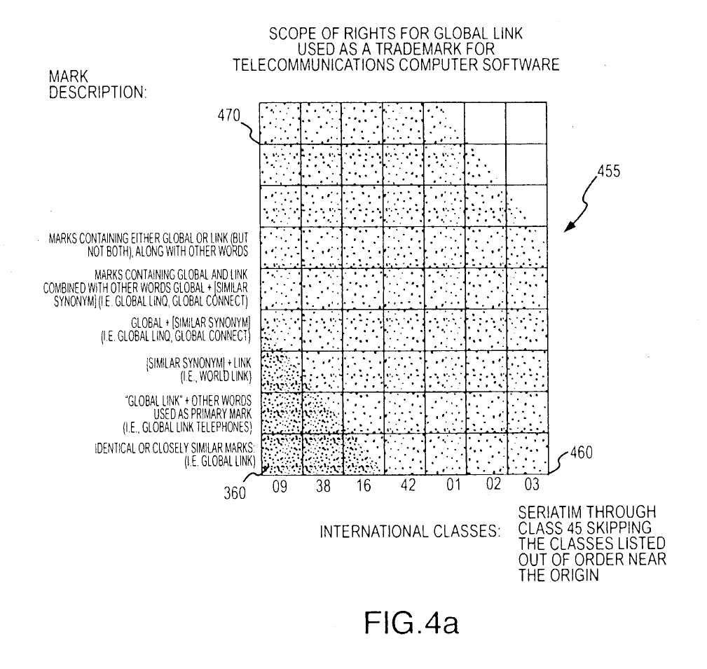

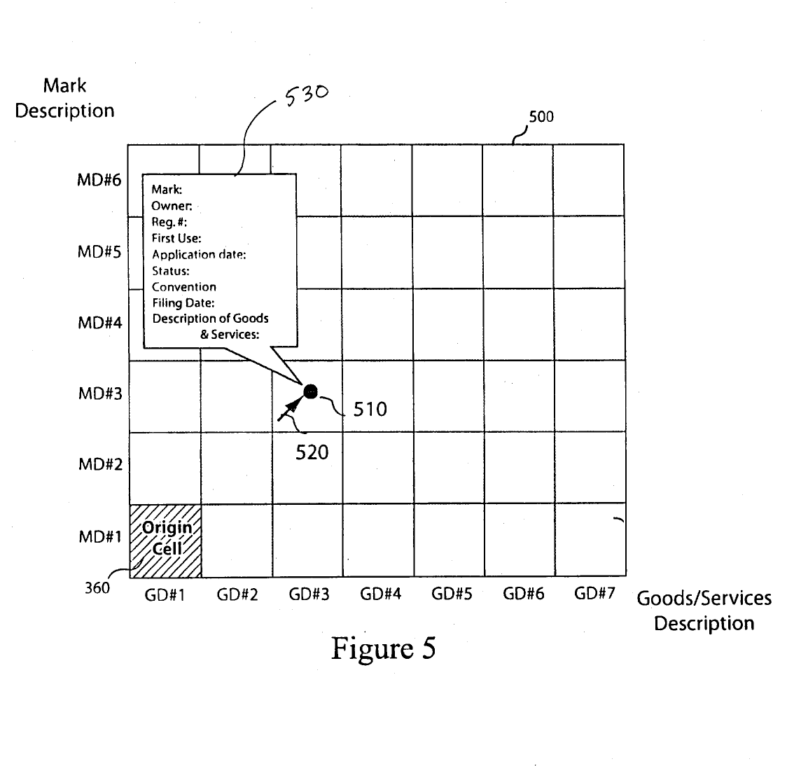

FIG. 4 illustrates a populated GUI 400 in accordance with one embodiment of the present invention. Once the graph illustrated in FIG. 3 is created, user selectable data points may be added thereby creating the interactive interface 400 shown in FIG. 4. For example, user selectable data point 430 is shown in GUI 400. Data point 430 is generated from a trademark from a search report having a goods and/or services description GD#3 and a mark description MD#2.

The various data points in GUI 400 may be shaded in accordance with their relationship to the searched trademark to further graphically clarify the nature of the data behind the data points. Legend 425 in FIG. 4 provides several examples of possible shadings. In the illustrated example, the trademark associated with interactive data point 435, having goods and/or services description GD#2 and mark description MD#1 would be a potential high priority enforcement candidate or may potentially provide a problem in a clearance, due to its close proximate relationship to the goods and/or services and mark description of the searched trademark, which would be placed in the cell adjacent to the origin 360 (referred to herein as the origin cell).

The information associated with a user selectable data point 430 may be stored in a database. If selected, the GUI 400 invokes a retrieve and display tool to retrieve information associated with user selectable data point 430 and thereafter display the information on a computer display. This information could include the mark, the goods and/or services offered under the mark or for which the mark is registered, the priority date (first use date, application date or convention priority date), the registration number and status (if the mark is registered), and the owner name. The information could also include the full description of the mark as is typically set out in a comprehensive search report, imaged documents, investigation reports, html links and other data or links.

As briefly alluded to previously, GUI 400 also provides a visual representation of the current “lay of the land” for the trademark that is the subject of the search shown at the origin cell 360. This is an important tool for the trademark professional to quickly disseminate a large amount of information in a short period of time. GUI 400 shows the searched trademark at the origin cell 360 and its corresponding goods and/or services descriptions GD#1 and mark description MD#1 in a first shading. Less important marks that have an associated goods and/or services description and mark description that are less material to the trademark owner are shown in a different shading and are plotted furthest from the origin. Marks that are more material to the trademark owner's scope of rights are shown closer to the origin. Marks that should be investigated for enforcement are illustrated in still another shading. Based upon this contrast in shadings for differing conditions, anyone can analyze GUI 400 and quickly assess the strengths and the weaknesses of the trademark.

FIG. 4a illustrates a graph 455 in accordance with another aspect of the present invention. The graph 455 of FIG. 4a is formed by a first axis 460 and a second axis 470. The International classes and the mark description associated with the trademark subject to the trademark search may form the goods and/or services description and the mark description associated with the origin. Origin 360 serves as the reference point for populating the remaining International class descriptions and mark descriptions along first axis 460 and second axis 470, respectively. The intersection of the International class column and mark description row for the trademark forms the origin or origin cell 360 of the graph 455.

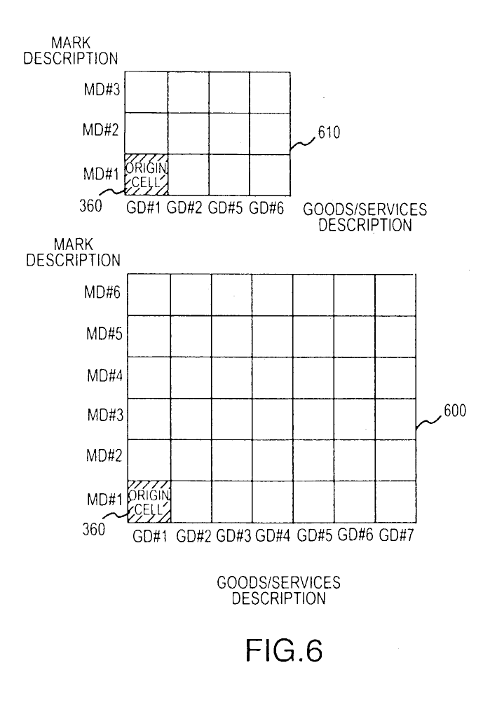

FIG. 5 shows a graphical user interface (GUI) 500 having an interactive data point 510. The user passes the mouse cursor 520 over an interactive data point 510. In response, pop-up window 530 is generated showing information associated with the trademark associated with interactive data point 510. Information in pop-up window 530 includes, but is in no way limited to, the mark description, the description of the goods and/or services, the International Class(es) involved the owner of the mark, when the mark was first used in commerce, any registration information and the database the mark was found from the search.

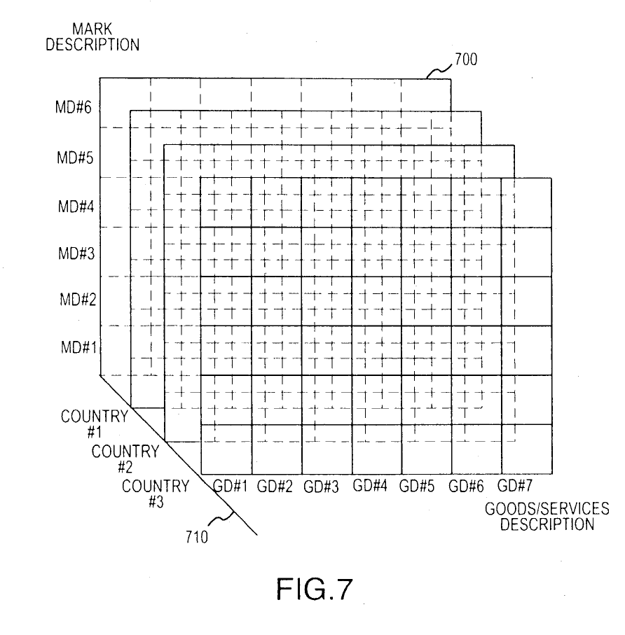

FIG. 6 illustrates a first graph 600 and a second graph 610 in accordance with another aspect of the present invention. The user selects less than all of the goods and/or services descriptions and mark descriptions from the first graph 600. A new graph 610 is generated having the user selected goods and/or services descriptions and mark descriptions populating the first and second axis of graph 610 respectively.

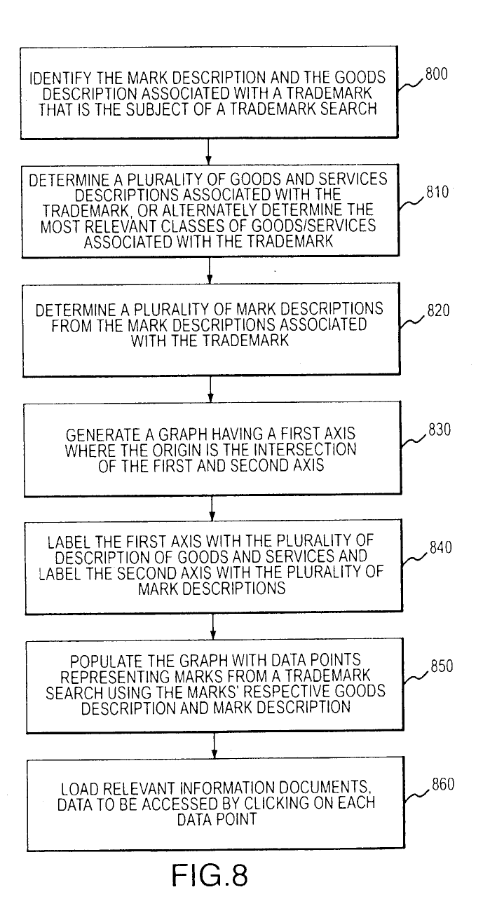

FIG. 7 shows a graph 700 having a third axis 710 in accordance with another aspect of the present invention. The third axis 710 is populated with a plurality of countries. In one embodiment, the third axis 710 is user selectable thereby overlaying the selected country onto graph 700 in response to a user selection. In another embodiment, graph 700 is a three dimensional depiction, thereby allowing concurrent viewing of all the countries along third axis 710.

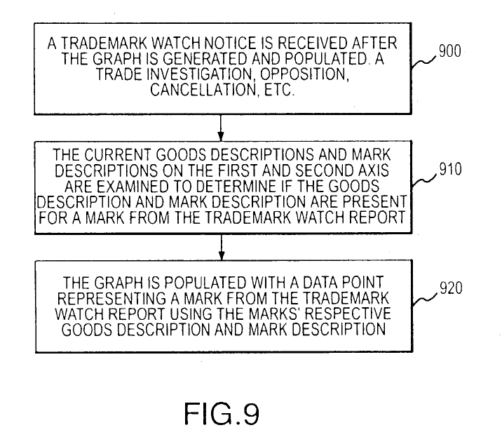

FIGS. 8 and 9 show flowcharts illustrating a method of the present invention.

The flowchart is illustrative of merely the broad logical flow of steps to achieve a method of the present invention and that steps may be added to, or taken away from, the flowchart without departing from the scope of the invention. Further, the order of execution of steps in the flowchart may be changed without departing from the scope of the invention. Additional considerations in implementing the method described by the flowchart may dictate changes in the selection and order of steps.

In general, the flowcharts in this specification include one or more steps performed by software routines executing in a computer system such as computer networks illustrated in FIGS. 1 and 2. The routines may be implemented by any means as is known in the art. For example, any number of computer programming languages, such as “C”, Pascal, FORTRAN, assembly language, etc., may be used. Further, various programming approaches such as procedural, object oriented or artificial intelligence techniques may be employed.

The steps of the flowcharts may be implemented by one or more software routines, processes, subroutines, modules, etc. Some considerations such as interrupt driven, polled, or other implementation schemes may affect the order of steps performed by software. A multiprocessing or multitasking environment could allow steps to be executed “concurrently.”

The flowchart of FIG. 8 is entered at step 800. At step 800, the mark description and goods and/or services description associated with a trademark is identified. The trademark is the subject of the trademark search performed by a trademark search entity. At step 810, the plurality of goods and/or services descriptions are determined using the goods and/or services description associated with the subject trademark. The goods and/or services descriptions may be determined by the intellectual property professional or the trademark search entity. The goods and/or services descriptions may also be determined manually or automatically based on key words in the trademark's goods and/or services description.

Continuing with step 820, a plurality of mark descriptions are determined using the mark description associated with the trademark subject to the trademark search. Similar to the selection of goods and/or services descriptions described previously, the plurality of mark descriptions may be determined by the intellectual property professional, the trademark search entity or automatically generated. Typically, the mark descriptions are chosen based upon various combinations of the words and letters associated with the trademark. Mark descriptions may include phonetically similar variations as well.

At step 830, the graph or user interface of the present invention is generated. The graph has a first axis and a second axis and an origin formed by the intersection of the first and second axis. The goods and/or services description and mark description associated with the trademark are placed at the origin. At step 840, the plurality of goods and/or services descriptions are placed on the first axis and the plurality of mark descriptions are placed on the second axis. Typically, the goods and/or services descriptions are prioritized on the first axis and the mark descriptions are prioritized on the second axis according to their respective similarity to the goods and/or services description and mark description of the trademark.

As shown in step 850, once the graph is generated, the data points representing marks from a trademark search report may be added thereby creating the user interface. Each data point is plotted on the graph using a trademark from the trademark search report. If a trademark does not correspond with either the goods and/or services descriptions or mark descriptions on the first or second axes, a new goods and/or services description or mark description may be generated and added to the respective axis. The data points may be user selectable. In other words, the data points are associated with information in a database that is displayed upon selection by a user.

As shown in step 900, the flowchart of FIG. 9 illustrates receipt of a trademark watch report after a graph is generated and populated with several data points. A trademark professional typically requests a trademark watch report to monitor the ongoing changes in the universe for a particularly important mark. Once the trademark watch report is received, at step 910, the current goods and/or services descriptions on the first axis and mark descriptions on the second axis are examined to determine the presence or absence of the goods and/or services description and mark description for a mark associated with the trademark watch report. If either is lacking, the respective goods and/or services description or mark description is added to the first or second axis at an appropriate location according to its relation to the description at the origin. At step 920, the graph is then populated with a data point representing a mark from the trademark watch report using the mark's respective goods and/or services description and mark description.

Portfolio Management

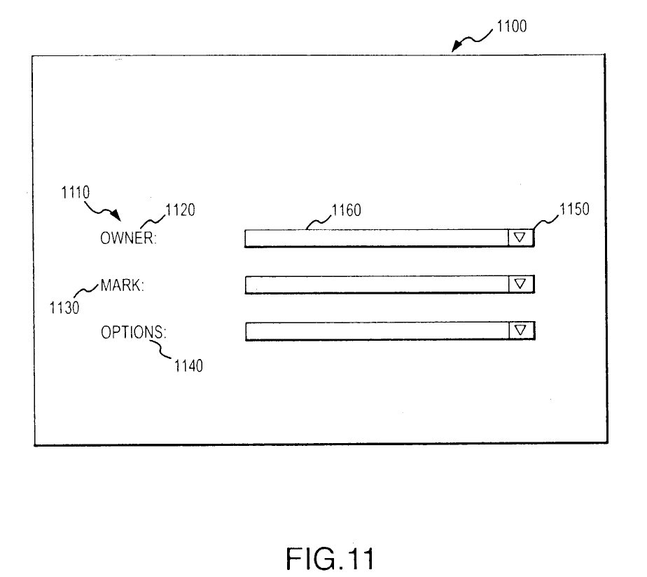

FIG. 11 shows a screen shot of an exemplary page of a trademark portfolio management system of the present invention. Screen 1100 includes selection options 1110 for accessing information stored in a database in a user-friendly format. Screen 1100 shows selection options 1110 including an owner designation 1120, a mark designation 1130 and an option designation 1140. The selection options shown in FIG. 11 are merely exemplary and other selection options such as a goods description, service description, International classification, filing date, first usage date, status and the like are possible. As shown in FIG. 11, each selection option 1110 includes a pull-down menu 1150 for making selections from a predefined list. Alternatively, or additionally, a user may enter one or more search terms into the box 1160 adjacent the desired selection option 1110.

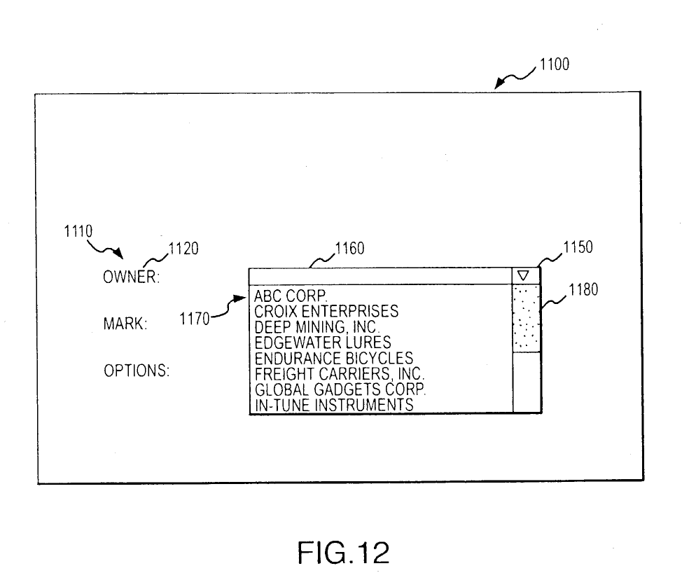

FIG. 12 shows a screen shot of screen 1100 wherein a user has selected a pull-down menu 1150 for the owner designation 1120 selection option 1110. The user may select the pull-down menu 1150, for example, through the use of a user input device such as a mouse, track ball, keyboard, touch screen, stylus or the like. The pull-down menu 1150 includes a list of owners 1170 having marks stored in a database. The pull-down menu 1150 further includes a scrolling means 1180 that may be selected by the user through the use of the input device to scroll through the complete list of owners in the database. If the number of owners is large enough such that the pull-down list becomes unwieldy, the pull-down list may be divided such as alphabetically to allow the user to more readily find the desired entry. Alternatively, the user may type one or more letters in the name of the desired owner into box 1160 and the pull-down menu may scroll automatically to one or more owner in the list matching the text entered in box 1160 as is known in the art. The user may further enter one or more search terms into the box 1160 to filter or search the list of owners 170.

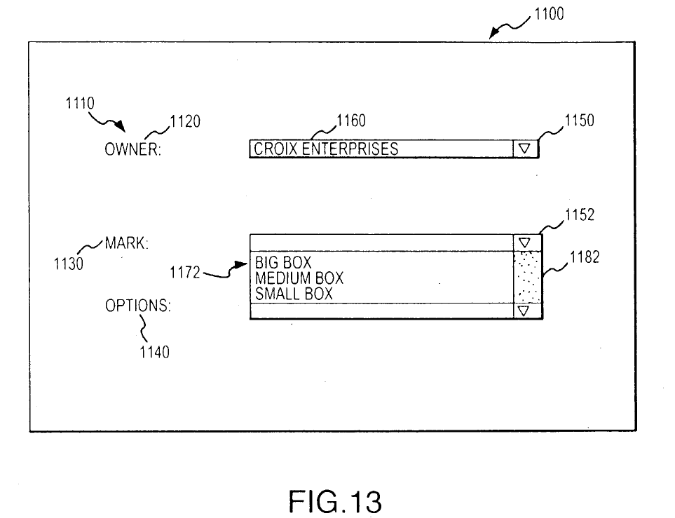

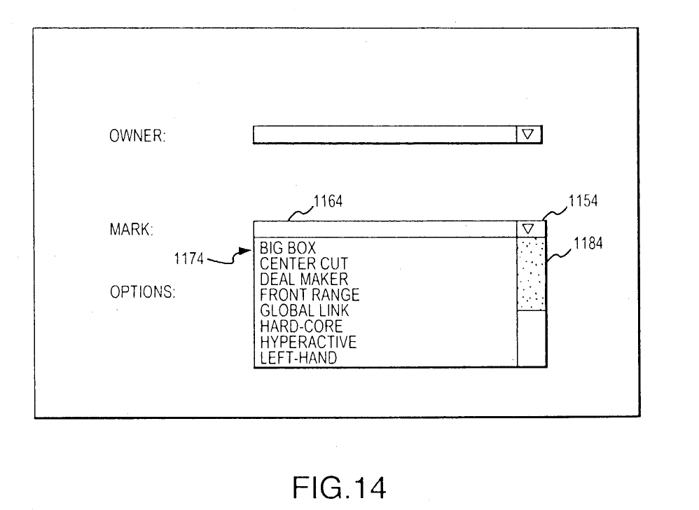

FIG. 13 shows a screen shot of screen 1100 wherein a user has first selected an owner (i.e., CROIX Enterprises) from the pull-down menu 1150 of the owner selection option 1120 shown in FIG. 12 and further selected the pull-down menu 1152 for the mark selection option 1130. The pull-down menu 1152 has filtered the list of marks stored in a database to include only the marks owned by the owner selected from the pull-down menu 1150 (i.e., CROIX Enterprises). In this particular example, the scrolling means 1182 extends along the entire side of the pull-down menu 1152 indicating that there are no more marks in this particular list 1172. In this manner, a mark owned by a particular entity may be more easily found if the entity is known. Alternatively, as shown in FIG. 14, the user may select a mark from a list of all the marks 1174 stored in a database. As described above, the user may select a desired mark from the pull-down menu 1154 through the use of an input device to select the scrolling means 1184, to type one or more letters of the mark in box 1164, to type one or more search terms in the box 1164, any combination of these, or any other searching or filtering means known in the art.

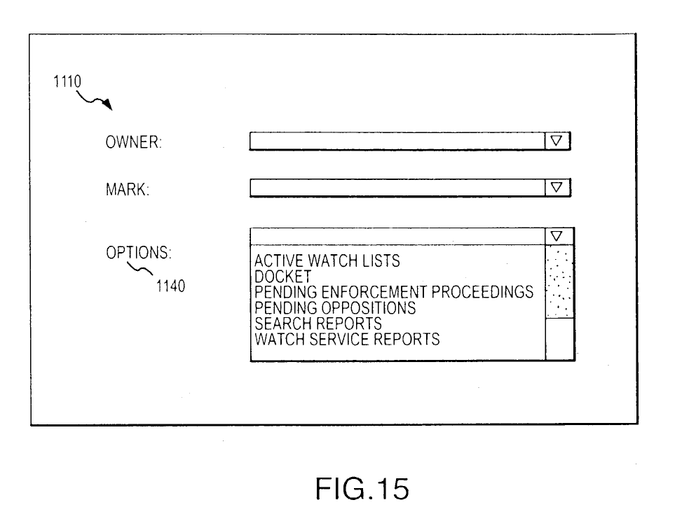

As shown in FIG. 15, the user may also select the options selection 1140 from the selection options 1110. These options are available in addition to searching for a particular owner and/or mark. The options available via selection 1140, for example, preferably include portfolio management tools that relate to more than one mark or owner stored in a database. Exemplary portfolio management tool options that are possible include, but are not limited to, reports, summaries, search tools, filtering tools and the like. For example, a report may be generated from the database to create a docket of deadlines (e.g., past-due, currently due or upcoming) such as responses to office actions, payment of maintenance fees, renewal deadlines, foreign filing deadlines and the like. Reports detailing active watch lists being monitored, search reports ordered, pending enforcement proceedings, opposition proceedings, litigation proceedings, licenses, co-existence agreements and settlement agreements may also be generated. The reports may be global (e.g., for the entire database) or may be filtered by any field in the database to provide a particular report. A global docket report, for example, may be generated to provide a listing of all deadlines for the entire portfolio entered in the database. Alternatively, a report may be generated by filtering one or more fields to provide a listing of deadlines within a particular time period, a listing of marks assigned to one or more particular law firm, attorney or other individual, a listing of marks involved in an investigation, an enforcement proceeding, an opposition proceeding and/or a litigation proceeding, any combination of these or a listing compiled by filtering the database entries pursuant to one or more other fields.

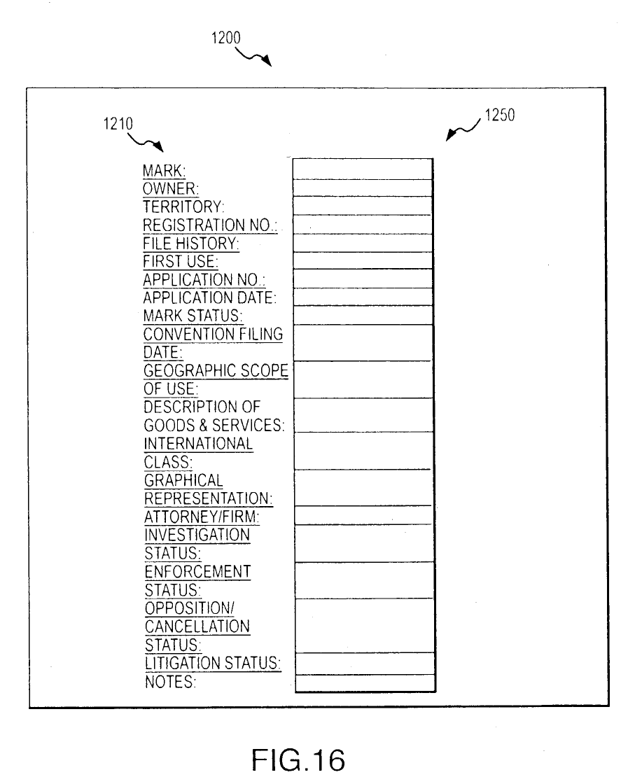

FIG. 16 shows a screen shot of an exemplary user interface 1200. The user interface may include a textual user interface, a graphical user interface (GUI), a combination of a textual user interface and a graphical user interface or any other type of user interface known in the art. The user interface 1200 shown in FIG. 16 includes categories 1210 and cells 1250 for displaying information for one or more marks related to the categories 1210. Some of the categories 1210, denoted by underlines in FIG. 16, also include links to more detailed information describing the category. By clicking on an individual category, a popup screen or other display shows information related to the selected category or all of the categories. The display, for example, may list the International classification system used to classify marks by goods and services, types of investigations and other proceedings that may involve a mark, and other information to explain the entries to a user that may or may not be entirely familiar with the various issues pertaining to the marks.

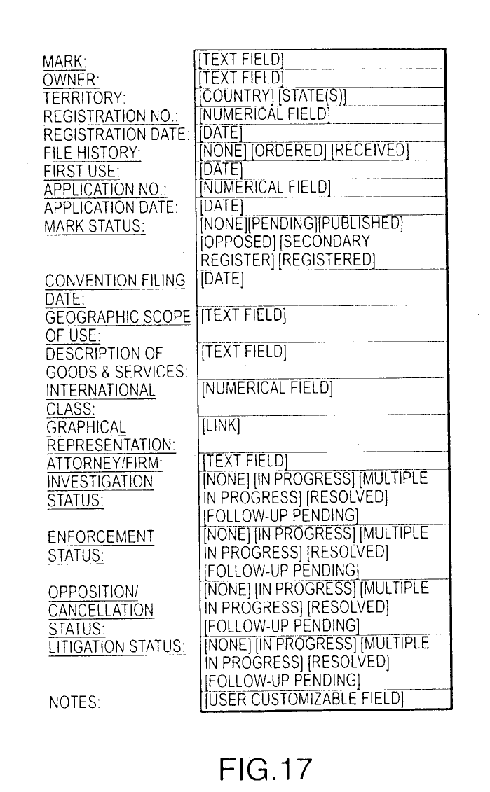

FIG. 17 shows an exemplary listing of fields that may be used for the categories listed in FIG. 16. The categories and the fields shown in FIG. 17, however, are merely exemplary and may include any other categories or fields to assist in the management of the portfolio. In addition, particular marks may only include entries for a portion of the available categories. An unregistered mark having common law rights, for example, will not have entries related to registration numbers, application dates and the like. The categories and fields may also be user customizable, such as utilizing Ecco formatting, or other user customizable interfaces.

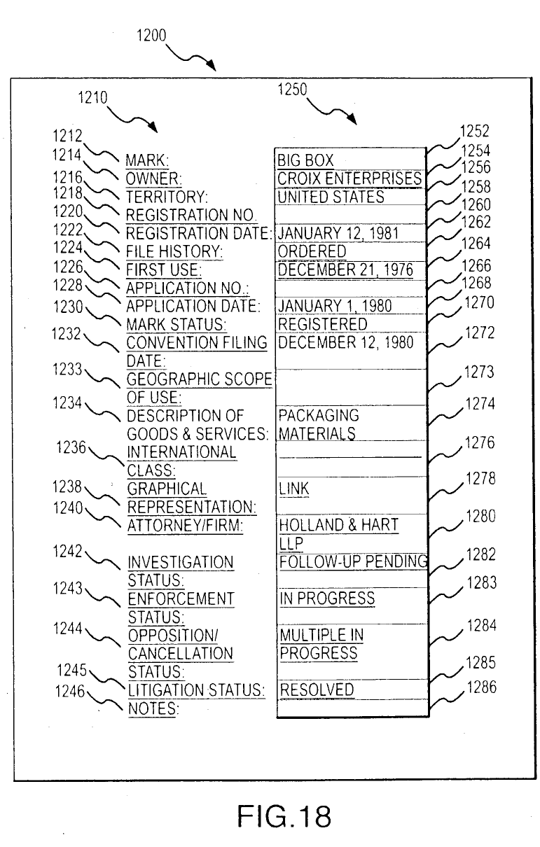

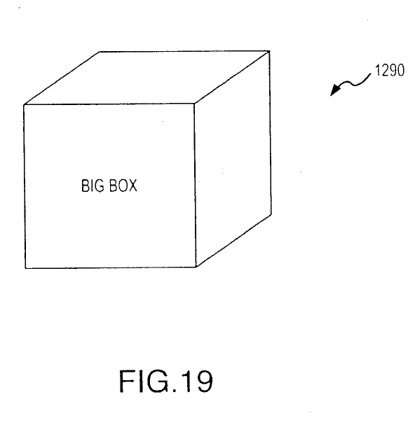

FIG. 18 further shows an exemplary mark “Big Box” in the user interface 1200 of FIG. 16. The mark category 1212 includes the name of the mark, “Big Box”, in cell 1252. As denoted by the underline, the cell 1252 includes a link to further information about the mark. The link, for example, may link to one or more image file (e.g., a JPEG, TIF, PDF, BMP or other image file) that depicts the mark in graphical form. If the mark has been used in different manners, the image file may further include images of each commercial use of the mark. The image file may be displayed on the user's monitor, to the user by printing the image file and/or displayed in any other manner known in the art. In FIG. 19, for example, the mark “Big Box” 1290 is shown including graphics in the manner in which it has been used in commerce to identify a particular good or service. The image file(s), thus, include the ability to display more than plain text of the mark. The image file(s), for example, may include graphics, colors, packaging or other images that are desired to be stored. The image files may be linked such as via a hypertext link, may be stored as a related file in a document management system, or may be accessed by any other linking means known in the art.

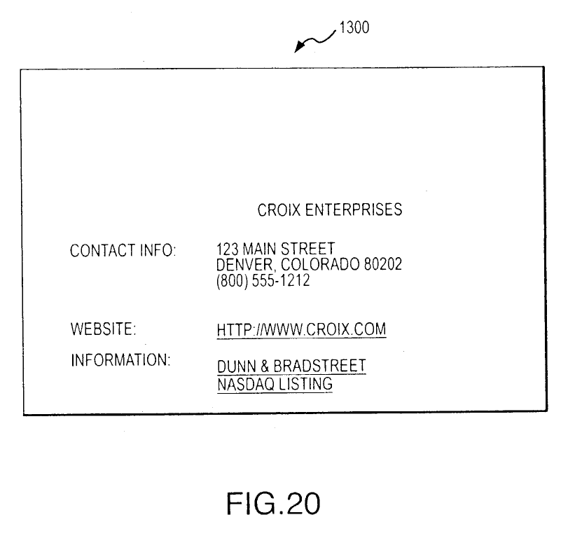

In FIG. 18, the owner category 1214 includes a cell 1254 listing the name of the owner of the mark, “CROIX Industries.” Again, the contents of the cell are linked to further information about the owner, such as a user interface 1300 shown in FIG. 20. The user interface 1300, for example, may include information about the owner, such as contact information, operation locations, distribution markets, market shares, product lines, services offered, press releases, and links to further information. The user interface, for example, may include links to the owner's web site, on-line marketing web sites selling the product or service, links to web sites for ordering additional information on the owner such as Dunn & Bradstreet reports, stock exchange listings, SEC publications, and the like.

The interface may further download information to record it for future use. After linking to a company's web site, for example, the interface could download the web site, such as in a PDF format, to record the web site usage before the owner of the site modifies or removes the site in response to a demand letter. Records such as these, for example, may be useful to show prior enforcement actions in which other companies respected the rights of a given mark.

The user interface 1200 further includes a territory category 1216 that lists the country, state, commonwealth, province or other territory in which the mark is used or registered. The territory listed in cell 1256, the United States, further includes a link to the United States Patent and Trademark Office website where further information about the mark may be obtained.

FIG. 18 further shows a registration number category 1218, which lists one or more registration numbers for any registrations obtained in the territories in which the mark is used. The registration numbers further include links to document or image files showing the actual registrations of the mark. By selecting the registration number entry in cell 1258, for example, a user may link to a PDF image file showing the actual registration documents for the particular mark. If the documents are not stored in the system, however, the system may prompt the user to order the registration. The order may be placed automatically by the system with an appropriate vendor, such as through an electronic message. Communication with a vendor through e-mail, facsimile, instant messaging, a paging network or other electronic communication methods, for example, may facilitate an automatic order being placed to receive the registration. Alternatively, the system may prompt an individual to order the desired registration and may further provide that individual the information to place the order. The system may further receive the registration, whether ordered automatically or not, in an electronic format and place the registration into the database or other document management system automatically. Alternatively, the registration may be manually scanned and stored by the system for future retrieval.

The user interface 1200 further includes a registration date category 1220, which includes registration date information in cell 1260 for each registration of the mark. A file history category 1222 is also included in user interface 1200 and includes an indication of whether a file history has been ordered and/or whether the file history has been received. Again, if the file history has not been ordered, the system includes a link for directly ordering the filed history from a suitable vendor. If the file history has been ordered, the user may link to the order information such as the date the order was placed, the vendor, the cost, a purchase order or other confirmation number, and the anticipated delivery date. If the file history has been received, a user may link to image or document files showing the file history.

The user interface 1200 further includes a first use category 1224, which includes a date on which the mark was first used in cell 1264. The first use category 1224 may indicate the first absolute use of the mark, or may further include the dates of the first uses of the mark in one or more of the applicable territories in which the mark is used. The cell 1264 further includes a link to an image file that includes an image of the mark as it was first used in each territory listed in the cell 1264.

The user interface 1200 also includes an application number category 1226, which includes application numbers for any registration applications filed in various territories in cell 1266. The cell 1266 links to an image or document file that includes the registration application filed with the particular territory for the application number listed in cell 1266. Again, the registration application(s) may be displayed for the user on a monitor, printed for the user and/or displayed in any other method known in the art.

FIG. 18 further shows an application date category 1228, which includes one or more application dates listed in cell 1268 for each of the registration applications filed in various territories. The user interface 1200 further includes a convention filing date category 1232 for displaying any applicable priority dates for the various territories in cell 1272.

As shown in FIG. 18, the user interface 1200 includes a mark status category 1230, which shows whether the mark is pending, published, opposed, listed on the secondary register, registered or abandoned in cell 1270. Other status indicators, however, are also possible. Depending upon the mark status, the system may prompt the user to take a particular action. If the mark status is listed as pending, for example, the system may prompt the user to add the mark to a watch service if the mark is not already on an active watch service. If the status is listed as abandoned, however, the system may prompt the user to remove the mark from a watch service.

The geographical scope of use category ______ further allows for determining the scope of common law rights by identifying where an unregistered mark has been used in cell ______. Thus, prior users to a registered mark may be identified and tracked to ensure that they don't expand their use and erode the registered mark's scope of rights.

The user interface 1200 also includes a description of goods and services category 1234 associated with the mark. A text field is displayed in cell 1274 and includes a description of the goods and services associated with the mark. An International Class category 1236 is also shown on user interface 1200. The cell 1276 includes one or more International Class associated with the mark.

The graphical representation category 1238 is shown in FIG. 18 as including a link in cell 1278 to a graphical representation of the mark as discussed above. Any of the graphical representations discussed above with reference to FIGS. 3 through 7. Alternatively, the user interface 1200, may include the graphical representation without requiring a user to link to another location to view the representation. The graphical representation may be generated from the data stored in the database each time the user links to the graphical representation or selects the user interface 1200 for a particular mark. In this manner, the graphical representation is updated using new data stored in the database. Data received from a watch list, for example, will automatically be populated when the graphical representation is generated.

FIG. 18 shows the user interface further includes an attorney/firm category 1240. The attorney/firm category 1240 is used to monitor responsibility for the particular mark. Thus, the cell 1280 includes an individual or organization that is responsible for filing, maintaining or monitoring the mark. An in-house counsel, for example, could use the attorney/firm category 1240 for assigning the registration of the mark to an outside counsel and keeping track of which attorney has responsibility of the mark. An attorney may further use the attorney/firm category 1240 to manage a portion of the portfolio assigned to her by filtering any reports or information to only include that portion of the portfolio. The cell 1280 may further link to information for a particular attorney or firm, such as contact information, an attorney or law firm web site, a biography of the attorney or firm (e.g., Martindale-Hubbell information) and the like.

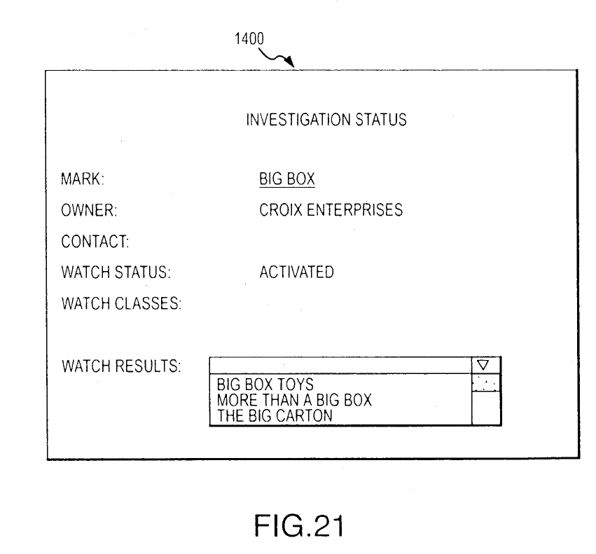

The investigation status category 1242 also includes a status in cell 1282. The status, for example, could include None, In Progress, Completed, Follow Up Pending or the like. If an investigation has begun, the cell 1282 further includes a link to information related that investigation. As shown in FIG. 21, for example, the Investigation Status user interface 1400 includes information related to an investigation. The interface 1400 includes the mark, along with a link back to user interface 1200,the owner, contact information, a watch status, a watch class and watch results. The watch status includes a flag indicating whether a watch is activated or de-activated. If the watch status flag is activated, the interface 1400 further includes one or more watch class indicating which classes are being monitored. The interface further includes a pull-down menu for identifying watch results. The user may select any of the watch results to link to a user interface for the particular mark found by the watch service. The link, for example, provides a user interface similar to the user interface 1200 shown in FIG. 18 for the watched mark, although the link need not contain the identical information to the user interface 1200.

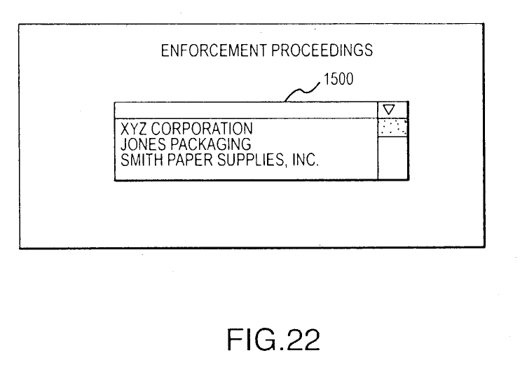

The enforcement status category 1243 is shown in FIG. 18 and includes a status in cell 1283. The status in cell 1283 relates to various types of enforcement proceedings for the mark. An enforcement proceeding, for example, may include sending a demand letter, negotiating a co-existence agreement, acquiring a mark and the like. FIG. 22 shows an enforcement proceedings user interface that may be linked to via cell 1283 of FIG. 18. The interface includes a pull-down menu 1500 that may be used to select from a list of enforcement proceedings. The pull-down menu 1500, for example, may be utilized to link to documents such as demand letters, settlement agreements, co-existence agreements that relate to a mark. Maintaining these record in a database that may be easily accessed allows an owner to maintain consistent enforcement policies with respect to a mark regardless of whether a variety of individuals have had responsibility to police a mark over a period of time. For example, if an attorney responsible for policing a given mark becomes aware of a mark for which a co-existence agreement has already been signed, the attorney will readily find the agreement and will forego sending a demand letter to the owner of the competing mark.

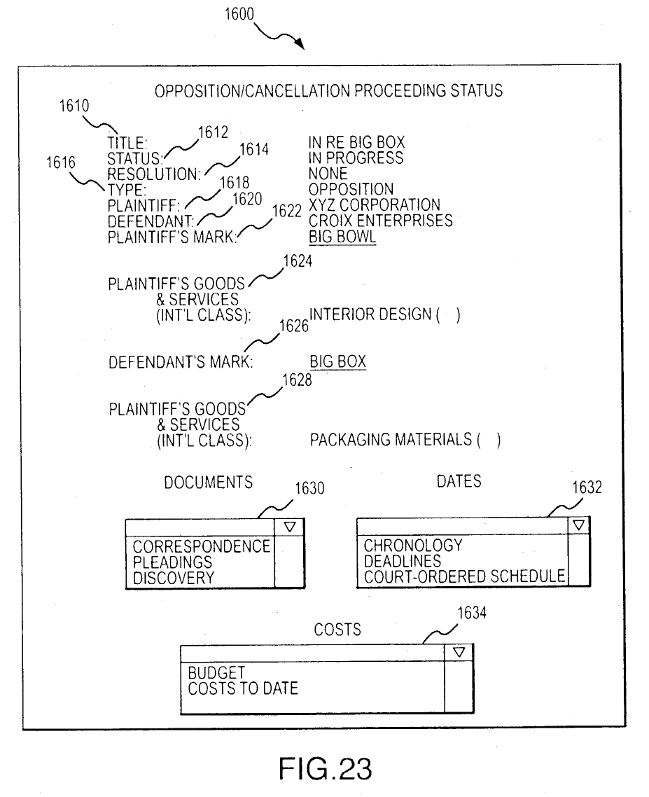

The user interface 1200 of FIG. 18 further includes an opposition/cancellation status category 1244, which includes a status in cell 1284 relating to various types of opposition and cancellation proceedings for the mark. The opposition and cancellation status in the cell 1284, for example, may include flags such as None, In Progress, Multiple In Progress, Resolved, Follow-Up Pending and the like. If an opposition or cancellation proceeding is in progress, has been resolved or is being followed-up, the user can link to information about various opposition and/or cancellation proceedings involving the mark. If the mark has been involved in multiple opposition and/or cancellation proceedings, the link may include a pull-down menu for such as described with respect to the enforcement proceedings in FIG. 22 from which a user may select an opposition or cancellation proceeding involving the mark. When a user selects an opposition or cancellation proceeding from the pull-down menu, the user links to another user interface 1600 including information relating to the particular opposition or cancellation proceeding, such as shown in FIG. 23. The opposition or cancellation proceeding information includes a title field 1610, status field 1612, resolution field 1614 and type field 1616. The title field 1610 identifies the parties to the proceeding. The status field 1612 identifies if the proceeding is in progress, resolved or being followed-up. If the proceeding has been resolved, the resolution field 1614 indicates how the proceeding was resolved, such as via a settlement, judgment or the like. The type of proceeding is also identified in the type field 1616, which includes, for example, opposition, cancellation and the like.

The opposition and/or cancellation proceeding information further includes fields 1618 and 1620 identifying the parties as a plaintiff or defendant, respectively. Fields 1622 and 1626 further identify the marks of the parties, and fields 1624 and 1628 identify their respective International class designations. The opposition and/or cancellation information further includes information relating to the proceeding, such as documents, dates and costs. The information may be included in the user interface 1600 or may be linked to the interface such as through pull-down menus 1630, 1632 and 1634.

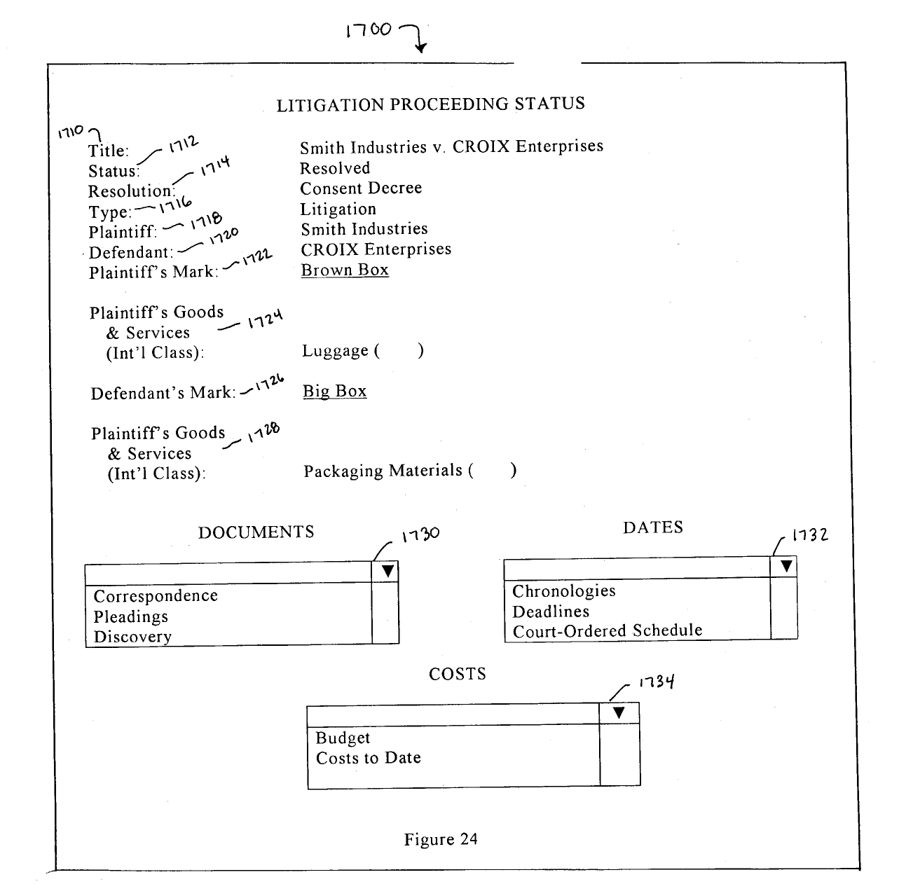

The user interface 1200 of FIG. 18 further includes a litigation status category 1245, which includes a status in cell 1285 relating to various types of litigation proceedings for the mark. The litigation status in the cell 1285, for example, may include flags such as None, In Progress, Multiple In Progress, Resolved, Follow-Up Pending and the like. If a litigation proceeding is in progress, has been resolved or is being followed-up, the user can link to information about various litigation proceedings involving the mark. If the mark has been involved in multiple litigation proceedings, the link may include a pull-down menu for such as described with respect to the enforcement proceedings in FIG. 22 from which a user may select a litigation proceeding involving the mark. When a user selects a litigation proceeding from the pull-down menu, the user links to another user interface 1700 including information relating to the particular litigation proceeding, such as shown in FIG. 24. The opposition or cancellation proceeding information includes a title field 1710, status field 1712, resolution field 1714 and type field 1716. The title field 1710 identifies the parties to the proceeding. The status field 1712 identifies if the proceeding is in progress, resolved or being followed-up. If the proceeding has been resolved, the resolution field 1714 indicates how the proceeding was resolved, such as via a settlement, judgment or the like. The type of proceeding is also identified in the type field 1716, which includes, for example, litigation, mediation, arbitration and the like.

The opposition and/or cancellation proceeding information further includes fields 1718 and 1720 identifying the parties as a plaintiff or defendant, respectively. Fields 1722 and 1726 further identify the marks of the parties, and fields 1724 and 1728 identify their respective International class designations. The litigation information further includes information relating to the proceeding, such as documents, dates and costs. The information may be included in the user interface 1700 or may be linked to the interface such as through pull-down menus 1730, 1732 and 1734.

FIG. 18 further shows the user interface further includes a note category 1246 for which user customizable comments may be recorded in cell 1286. The comments are recorded in connection with a particular mark in cell 1286. The system can also utilize the recorded comments for searching or filtering as described above. Notes identifying related marks, for example, may be recorded under the note category 1246 and used to identify related marks through searching and/or filtering.

In the foregoing specification, the invention has been described with reference to a specific exemplary embodiment thereof. It will, however, be evident that various modifications and changes may be made thereunto without departing from the broader spirit and scope of the invention as set forth in the appended claims. For example, various programming languages and techniques can be used to implement the disclosed invention. Also, the specific logic presented to accomplish tasks within the present invention may be modified without departing from the scope of the invention. Many such changes or modifications will be readily apparent to one of ordinary skill in the art. The specification and drawings are, accordingly, to be regarded in an illustrative rather than a restrictive sense, the invention being limited only by the provided claims.

We claim:

1. A method for managing a trademark portfolio, the method comprising:
maintaining a database including a plurality of mark records, each of the records comprising a plurality of entries;
providing a user interface for selecting at least one of the plurality of mark records;
displaying the plurality of entries for the selected mark; and
providing a link to further information for at least one of the plurality of entries.

2. The method of claim 1, wherein the further information comprises documents relating to the mark.

3. The method of claim 2, wherein the documents comprise image files.

4. The method of claim 1, wherein the further information comprises information relating to an investigation involving the mark.

5. The method of claim 1, wherein the further information comprises information relating to an enforcement proceeding involving the mark.

6. The method of claim 1, wherein the further information comprises information relating to an opposition proceeding involving the mark.

7. The method of claim 1, wherein the further information comprises information relating to a cancellation proceeding involving the mark.

8. The method of claim 1, wherein the further information comprises information relating to a litigation proceeding involving the mark.

9. The method of claim 1, wherein the further information comprises a web site.

10. The method of claim 9, wherein the web site comprises a site of the owner of the mark.

11. The method of claim 9, wherein the web site comprises a site of a competitor of the mark's owner.

12. A system for managing a trademark portfolio, the system comprising:
a database including a plurality of mark records, each of the records comprising a plurality of entries;
a user interface operable to select a first mark record; and
a display device operable to display the plurality of entries for the selected first mark record,
wherein the interface is operable to provide a link to further information for at least one of the plurality of entries.

13. The system of claim 12, wherein the further information comprises documents relating to the mark.

14. The system of claim 13, wherein the documents comprise image files.

15. The system of claim 12, wherein the documents comprise pleadings.

16. The system of claim 12, wherein the further information comprises identification of related marks.

17. The system of claim 12, wherein the link automatically prepares one or more of the group comprising a demand letter, a complaint, a co-existence agreement, an assignment, a settlement agreement and a license agreement.

18. The system of claim 17, wherein the link automatically orders one or more of the group comprising a file history, a search report, a registration, a product identified by the mark and marketing materials related to the mark.

19. A system for analyzing trademark rights, the system comprising:
a database comprising a plurality of marks, each of the marks further comprising a mark description and a goods and/or services description; and
an interactive graphical user interface adapted to select a first mark and graphically display the mark in comparison to a second mark selected from the database, wherein the interface:
identifies the mark description and the goods and/or services description associated with the mark;
generates a graph having a first axis and a second axis, wherein an origin of the graph comprises an intersection of the first and second axes, the first axis having one or more descriptions of goods and/or services and the second axis having one or more mark descriptions, wherein the origin comprises the goods and/or services description and the mark description associated with the trademark;
populates the graph with at least one data point, the act of populating comprising:
locating a mark description and a goods and/or services description associated with a mark from the trademark search on the first and second axes; and
plotting a data point on the graph using the goods and/or services description and the mark description associated with the mark from the trademark search.

20. The system of claim 19, wherein the interface comprises a link to display further information to supplement the field selectable by a user may be selected and displayed on the graphical user interface
